(19) United States
(12) Patent Application Publication
(10) Pub. No.: US 2013/0074781 A1
(43) Pub. Date: Mar. 28, 2013

(54) Escape Preventor

(71) Applicant: Deborah L. Campopiano, Cranston, RI (US)

(72) Inventor: Deborah L. Campopiano, Cranston, RI (US)

(21) Appl. No.: 13/196,931

(22) Filed: Sep. 22, 2011

(51) Int. Cl. A01K 15/04; A01K 29/00

(52) U.S. Cl. 119/712; 119/174

(57) ABSTRACT

The Escape Preventor is a device made out of plastic tubing with a spiral cut that begins on one end and ends at the other. A tube is threaded onto both sides of a pet harness. This prevents the pet from squeezing through vertical slots that are used to confine the animal to that area.

### BACKGROUND OF THE INVENTION

Pets can escape through the vertical slots of fencing, balconies, etc. They squeeze through these slots to get to the other side. Electric collars that send a shock to the pet are painful for the pet. They also still allow the pet to escape. The owner then has to find the pet.

### BRIEF SUMMARY OF THE INVENTION

The Escape Preventor is made up of two tubes to be threaded onto a pet harness in order to add width to the pet to prevent it from escaping through vertical slots that may be found on fencing, balconies, etc.

### BRIEF DESCRIPTION OF THE SEVERAL VIEWS OF THE DRAWING

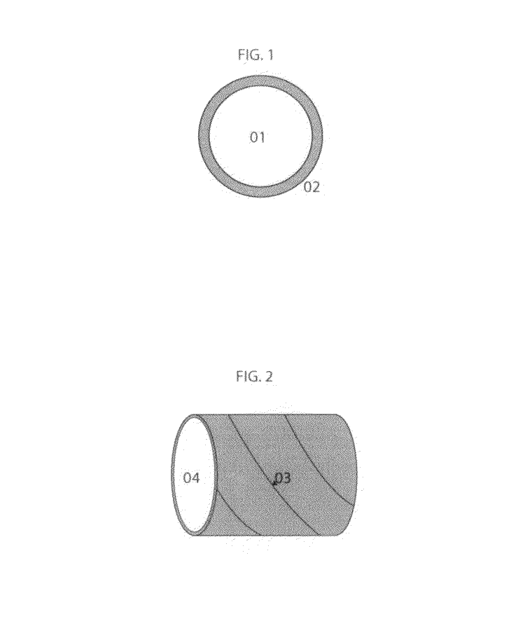

FIG. 1 represents the front view
Part is made out of plastic tubing

01—represents the hollow part of the tubing

02—(grayed in) represents the thickness of the tubing

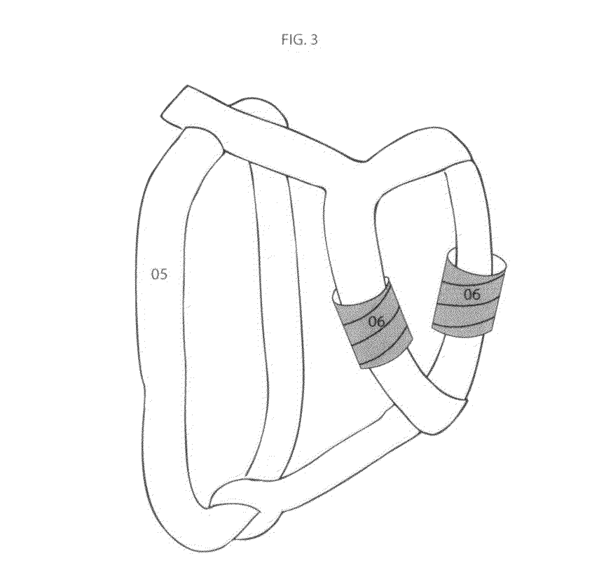

FIG. 2 represents the side view
Tube is spiral cut to allow it to be threaded onto a pet harness

03—represents the spiral cut on tubing

04—represents the opening on the tubing

FIG. 3 represents the Escape Preventor as applied to a pet harness
Tubes put onto both sides of harness

05—represents the pet harness

06—represents the Escape Preventor tubing as applied to the pet harness

### DETAILED DESCRIPTION

The Escape Preventor uses two spiral cut tubes (FIG. 3, 06) that are threaded onto a pet harness (FIG. 3, 05) in order to make the pet wider. This prevents the pet from escaping through vertical slots. The tubes are made from plastic. The tubes are spiral cut (FIG. 2, 03) on a lathe in order to allow one to thread it onto a pet harness. The spiral cut on the tubes allows for the tubing to easily twist around the pet harness.

1. The Escape Preventor will add width to a pet's harness that will prevent the pet from escaping through vertical slots that can be found on fencing, balconies, etc.

2. The Escape Preventor spiral tubing is easily threaded on and off of a pet harness.
